(19) United States
(12) Patent Application Publication
(10) Pub. No.: US 2004/0071146 A1
(43) Pub. Date: Apr. 15, 2004

(54) Jitter correction during multiplexing

(76) Inventor: Thomas Belling, Munchen (DE)

Correspondence Address: MORRISON & FOERSTER LLP, 1650 TYSONS BOULEVARD, SUITE 300, MCLEAN, VA, 22102, US

(21) Appl. No.: 10/468,783

(22) PCT Filed: Jan. 28, 2002
(86) PCT No.: PCT/DE02/00288

(30) Foreign Application Priority Data
Feb. 22, 2001 (DE) 101 08 551.6

(51) Int. Cl. H04L 12/28

(52) U.S. Cl. 370/395.52

(57) ABSTRACT

Jitter and time delays during the transmission of payload packets via a packet-switched data network are avoided by means of a device and a method for transmitting payload packets (1, 2, 3, 4) in a packet-switched network (9), wherein payload packets (1, 2, 3) on their path (14, 19, 17, 20) through the data network (9) are combined (11) on a number of occasions to form a group packet (5) which is to be transmitted along part (14) of the path. After the group packet (5) has been transmitted (14) along part (14) of the path, said payload packets are individually processed (15, 19, 16, 17, 18, 20). The time information (12,13) which is to be transmitted in a group packet (5) is used to reestablish (15) the time delay of payload packets (1, 2, 3) in relation to each other.

The invention relates to a method and devices for transmitting payload packets in a packet-switched data network.

During the transmission of very efficiently encoded voice data in accordance with standard mobile radio standards via an internet protocol-based packet-switched data network using a standard protocol stack according to RTP/UDP/IP standards, the combined RTP/UDP/IP header in transmitted data packets may be larger than the proportion of payload data in the data packet. If, as part of a multiplex method, payload packets coming from different packet streams (for example different mobile users telephoning each other) having packets of varying size and/or frequency are packed in multiplex packets (group packets), transmitted in multiplex packets and then removed again from the multiplex packet by a demultiplexing device after transmission via the data network, it is possible for what is referred to as jitter to occur, in other words a change in the time intervals of payload packets in relation to each other compared to their time intervals in relation to each other before transmission in a multiplex packet.

This problem is encountered in particular during the transmission of payload packets for mobile radio communication, as some voice-encoding methods work with a variable bit rate here, and furthermore as during a connection (for example between two mobile users), multiplexing (packing of payload packets to form one group packet) and demultiplexing (and separate further processing/further transmission of payload packets received in one group packet, in a demultiplexer) as referred to above can be carried out along a path through a data network on a number of occasions one after the other, so that it is hardly suitable to compensate the jitter generated in this way by means of buffering on account of the resultant delay generated and the necessary buffer size.

The object of the present invention is to sustain the time delay of payload packets transmitted in multiplex packets (group packets) via the data network in relation to each other, entailing a slight time delay of the transmission, as flexibly and efficiently as possible during the transmission of payload packets in a packet-switched data network, in particular an RTP/UDP/IP data network. The object is achieved-in each case through the subject matter of the independent claims.

Payload packets, which are combined on a number of occasions on their path through a packet-switched data network to form a multiplex packet (group packet) by a multiplex device, are transmitted in this multiplex packet along a part of their path through the packet-switched network and are removed from the transmitted multiplex packet for individual further processing (individual further transmission or transmission in another multiplex packet, exit from the data network), have the same time delay and overall a slight transmission delay in relation to each other according to the invention, even after transmission via the packet data network, so that jitter is effectively avoided. Compensation of jitter occurring due to multiplexing, transmission and demultiplexing after each transmission of payload packets in a group packet via a part section of the path through the data network by reestablishing the time delay of payload packets in relation to each other before a further transmission (for example in repacked group packets/multiplex packets) minimizes buffering, as, after each multiplexing transmission of payload packets in a group packet, only as much buffering is used in a buffer (to reestablish the time delay of payload packets in relation to each other), as is actually needed to compensate the jitter necessary for multiplexed transmission via this part of the path. (If, contrary to the invention, jitter is only compensated at the exit of a packet-switched data network, a considerably larger buffer size would be needed and a considerably larger buffer delay of the payload packages would occur, which is very undesirable for voice transmission as well as other data transmission).

To specify the time delay of payload packets before being combined to form a group packet (multiplex packet) for transmission together along a part of the path through the packet data network in this group packet for a demultiplexing device at the end of this part of the path, in the group packet, time information relating to the time delay of payload packets in relation to each other before transmission in this group packet (for example relative time delay of payload packets at the entry point in the case of the multiplexer establishing the group packet) can also be transmitted in the group packet in a variety of ways (time stamps).

During multiplexing (creation of a group packet out of several payload packets to be transmitted together in this group packet along a part of the path through the data network), it is possible to store and also transmit a time offset (time information) for example for each payload packet, said time offset specifying how much time has elapsed between the start of building the multiplex packet and the receipt or generation of this payload packet during multiplexing, and during demultiplexing it is possible to hand over or interpret this time offset for each payload packet at a point in time arising from the time of receipt of the group packet (multiplex packet) plus the time offset also transmitted for the respective payload packet. Alternatively, it is also possible in each case to use the time span between the receipt or generation of a payload packet (during multiplexing) and the dispatch of the multiplex packet as a time offset (time information), if in addition the total time between the start of building the multiplex packet and the dispatch of this multiplex packet is known to the recipient (demultiplex device, etc.) or is also transmitted to the recipient. It is furthermore possible to store payload packets in the multiplex packet according to the order in which they are received or developed (at the multiplexer generating the multiplex packet); if the recipient of the multiplex packet knows this storage rule, it only has to take the time offset of the next payload packet to be processed into consideration in each case during demultiplexing at a specific point in time and does not have to continue processing a multiplex packet until the corresponding point in time has been reached.

Further features and advantages of the invention are provided in the following description of an exemplary embodiment with reference to the drawing. In the drawing:

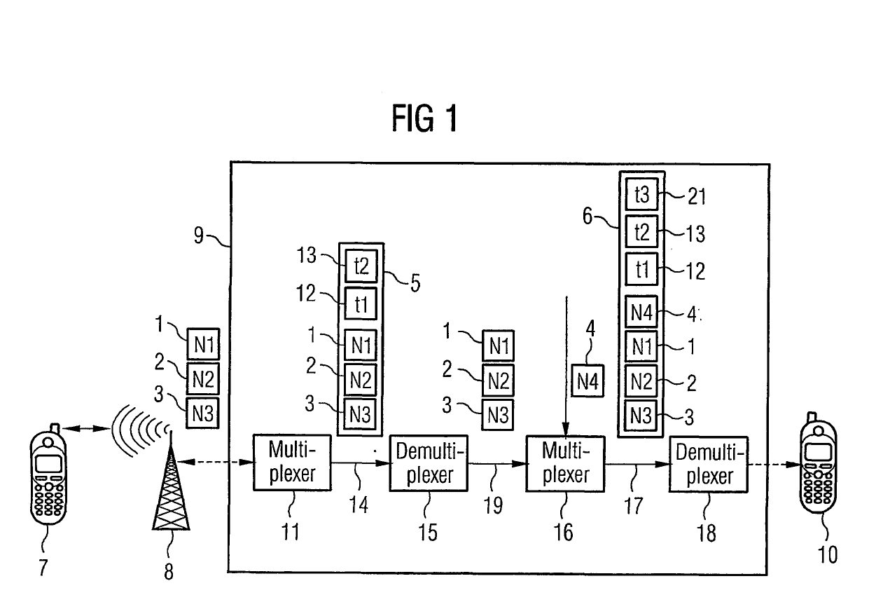

FIG. 1 shows a schematic view of the transmission of payload packets in group packets according to the invention;

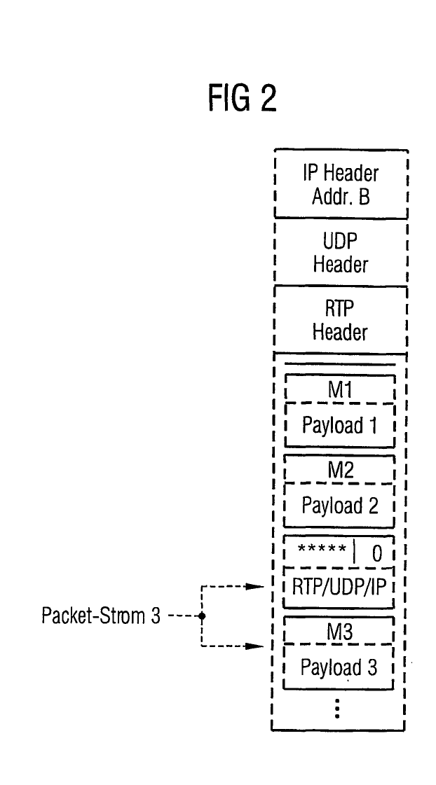

FIG. 2 shows a multiplex packet comprising several multiplexed payload packets.

FIG. 1 shows the transmission of payload packets 1, 2, 3, 4 individually and/or in group packets 5, 6 from a mobile station 7 via a receive device BTS 8 of a mobile radio network, along a path through a packet-switched data network 9 (possibly comprising several subnetworks) to another mobile station 10. In data network 9, voice data 1, 2, 3 based on speech input by at least one user at the mobile station 7 end is combined by a multiplex device 11 to form a group packet 5 (=multiplexing packet), with group packet 5 also containing the time delay of time information 12, 13 representing payload packets 1, 2, 3 in relation to each other, with group packet 5 being transmitted along a part 14 of the path of payload packets 1, 2, 3 via the data network 9, with the group packet 5 being received by a first demultiplexer 15 and the payload packets contained in group packet 5 being individually further processed again (individually forwarded/combined to form further group packets 6/exited from the network). After the demultiplexer 15, the payload packets 1, 2 are handed over to a multiplexer 16, which in the present case also receives payload packet 4 to be transmitted along path distance 16 of the data network 9 in the same direction and transmits payload packets 1, 2, 3, 4 along a part of the path 17 as far as a further demultiplexer 18, which again demultiplexes payload packets 1, 2, 3, 4 contained in group packet 6 and for example hands them over to a mobile station 10.

In a multiplexer 11, the time interval of arriving packets n1, n2, n3 in relation to each other is recorded as time information and is also transmitted in the multiplex packet 5 created in the multiplexer as time information 12, 13. In a buffer combining incoming payload packets at a multiplexer, the maximum time delay from when a payload packet enters until it is forwarded in a multiplex packet is preferably a maximum of 2 ms.

In a demultiplexer 15, time information 12, 13 contained in an incoming group packet 5 at demultiplexer 15 is used to again delay payload packets 1, 2, 3 in relation to each other when forwarding payload packets 1, 2, 3 from demultiplexer 15 (along section 19), for the same amount of time as they were delayed in relation to each other before multiplexer 11. For example, it is possible for time information 12 to represent the delay of payload packet 2 in relation to payload packet 1 and for time information 13 to represent the delay of payload packet 3 in relation to payload packet 2. It is also possible for the group packet to contain time information relating to each payload packet.

A demultiplexer can in particular be provided at a nodal point (switch, etc.) in a data network or between data networks, with the said demultiplexer receiving multiplex packets and/or payload packets from several directions and/or forwarding them in several directions.

By avoiding jitter according to the invention by means of a time delay (in a buffer) at each demultiplexer after a section 14/17 in data network 9, less buffer is needed than would be needed if buffering is only carried out at the exit from data network 9 and furthermore a considerably shorter time delay is generated in the transmission of payload packets.

The invention is particularly suitable for mobile radio networks, as the problem of having to transmit data packets of differing sizes and/or frequency when there is a number of voice-encoding methods which are standard in fixed networks usually does not arise.

According to the invention, it is also possible to perform only one multiplexing/transmission/demultiplexing (14) operation on (at least) one part of the path of payload packets through a data network 9, without having to provide a demultiplexer at the exit 20 of a data network 9.

1. Method for transmitting payload packets (1, 2, 3, 4) in a packet-switched data network (9), with payload packets (1, 2, 3) on their path (14, 19, 17, 20) through the data network 9 on more than one occasion:
being combined (11) to form a group packet (5) to be transmitted along a part (14) of the path and
being individually further processed (15, 19, 16, 17, 18, 20) after transmission (14) of group packet (5) along a part (14) of the path,
with time information (12, 13) to be transmitted in a group packet (5) being used to reestablish (15) the time delay of payload packets (1, 2, 3) in relation to each other.

2. Method according to claim 1, characterized in that time information (12, 13) is contained in a group packet (multiplex packet 5) relating to the payload packets (1, 2, 3) contained therein, with such time information representing the time offset between the start of building a group packet (5) and-the time of receipt (11) of the respective payload packet (1, 2, 3) to be added to the group packet (5).

3. Method according to claim 2, characterized in that during the demultiplexing (15) of a transmitted group packet (5) for individual further processing (19, 17, 20) of payload packets transmitted in the group packet, a further transmission (19) of a payload packet (1, 2, 3) is in each case delayed by a time corresponding to the time offset (12, 13) in relation to the receipt of the group packet (5).

4. Method according to one of the preceding claims, characterized in that time information (12, 13) is contained in a group packet (5) relating to each payload packet (1, 2, 3) contained therein, specifying how much time has elapsed between the receipt or generation of the payload packet (11) and the dispatch of the group packet (11), with the time span between the building and dispatch of the group packet preferably being transmitted therein (12, 13) or being known to a recipient (15) of the group packet (5).

5. Method according to one of the preceding claims, characterized in that payload packets (1, 2, 3) are stored in a group packet (5) according to the order (1/2/3) in which they are received where (11) the group packet (5) is created out of them (1, 2, 3).

6. Method according to claim 5, characterized in that in each case only the time offset (12, 13) of the next payload packet of a group packet (5) to be processed is taken into consideration and the further processing of payload packets of the group packet is preferably not continued until the applicable point of time for the next payload packet has been reached.

7. Method according to one of the preceding claims, characterized in that the further processing of some of the payload packets involves a further transmission in different group packets.

8. Method according to one of the preceding claims, characterized in that the data network is an RTP/UDP/IP data network.

9. Packet data transmission network, in particular for implementing the method according to one of the preceding claims, for transmitting payload packets (1, 2, 3) along a path (14, 19, 17, 20) through a packet-switched data network with at least
a first multiplex device (11) for packing several payload packets (1, 2, 3) into a first group packet (5),
a transmission section (14) for transmitting the group packet (5) along a first part (14) of a path of payload packets (1, 2, 3) through the data network (9),
a multiplex device (15) for further processing (19) several payload packets (1, 2, 3) contained in one group packet (5),
a second multiplex device (16) for packing payload packets (1, 2, 3) packed (11) into a group packet (5) and then unpacked again (15) into a further group packet (6),
a transmission section (17) for transmitting the further group packet (6) along a further part (17) of the path of payload packets (1, 2, 3) through the data network (9),
a further demultiplex device (18) for further processing the payload packets (1, 2, 3, 4) contained in the further group packet (6),
with a multiplex device comprising a device for adding to a group packet the time data representing the time delay of payload packets in relation to each other before the multiplex device,
with a demultiplex device comprising a delay device for delaying the dispatch of payload packets contained in a group packet in relation to each other by a time defined by the time data contained in the group packet.
